(19) United States
(12) Patent Application Publication
(10) Pub. No.: US 2021/0073457 A1
(43) Pub. Date: Mar. 11, 2021

(54) CIRCUIT DESIGN DEVICE, CIRCUIT DESIGN METHOD, AND STORAGE MEDIUM

(71) Applicants: Kabushiki Kaisha Toshiba, Tokyo (JP); Toshiba Electronic Devices & Storage Corporation, Tokyo (JP)

(72) Inventors: Jiro Hayakawa, Inagi Tokyo (JP); Naohito Kojima, Yokohama Kanagawa (JP)

(21) Appl. No.: 16/786,655

(22) Filed: Feb. 10, 2020

(30) Foreign Application Priority Data
Sep. 5, 2019 (JP) 2019-162222

(51) Int. Cl. G06F 30/3953

(52) U.S. Cl. CPC G06F 30/3953

(57) ABSTRACT

According to one embodiment, a circuit design device includes a classification unit and a generation unit. The classification unit is configured to classify a plurality of wires included in a circuit into a first wire group that includes at least one first wire and a second wire group that includes at least one second wire based on toggle rates of the plurality of wires. The generation unit is configured to generate, based on first information indicating a layout of the plurality of wires on a substrate, second information indicating a layout of the plurality of wires on the substrate and a first dummy wire, the first dummy wire being arranged in a first region within a first range from the first wire.

### CROSS-REFERENCE TO RELATED APPLICATIONS

This application is based upon and claims the benefit of priority from Japanese Patent Application No. 2019-162222, filed Sep. 5, 2019, the entire contents of which are incorporated herein by reference.

### FIELD

Embodiments described herein relate generally to a circuit design device.

### BACKGROUND

A layout of wires functioning as a circuit and a layout of dummy wires not functioning as the circuit are designed, in a stage of designing the circuit.

### BRIEF DESCRIPTION OF THE DRAWINGS

FIG. 1 is a block diagram explaining a hardware configuration of a circuit design device according to a first embodiment.

FIG. 2 is a conceptual drawing for explaining a net list according to the first embodiment.

FIG. 3 is a schematic diagram for explaining dummy metal pre-insertion layout information according to the first embodiment.

FIG. 4 is a block diagram for explaining a functional configuration of the circuit design device according to the first embodiment.

FIG. 5 is a flowchart for explaining dummy metal insertion processing in the circuit design device according to the first embodiment.

FIG. 6 is a conceptual drawing for explaining a post-classification net list according to the first embodiment.

FIG. 7 is a schematic diagram for explaining dummy metal post-provisional insertion layout information according to the first embodiment.

FIG. 8 is a schematic diagram for explaining dummy metal post-provisional insertion layout information according to the first embodiment.

FIG. 9 is a schematic diagram for explaining dummy metal post-provisional insertion layout information or dummy metal post-insertion layout information according to the first embodiment.

FIG. 10 is a flowchart for explaining dummy metal insertion processing in a circuit design device according to a second embodiment.

FIG. 11 is a schematic diagram for explaining dummy metal post-provisional insertion layout information according to the second embodiment.

FIG. 12 is a schematic diagram for explaining dummy metal post-provisional insertion layout information according to the second embodiment.

FIG. 13 is a schematic diagram for explaining dummy metal post-provisional insertion layout information or dummy metal post-insertion layout information according to the second embodiment.

FIG. 14 is a conceptual drawing for explaining a net list according to a third embodiment.

FIG. 15 is a schematic diagram for explaining dummy metal post-provisional insertion layout information according to the third embodiment.

FIG. 16 is a schematic diagram for explaining dummy metal post-provisional insertion layout information or dummy metal post-insertion layout information according to the third embodiment.

FIG. 17 is a block diagram for explaining a functional configuration of a circuit design device according to a fourth embodiment.

FIG. 18 is a flowchart for explaining dummy metal insertion processing in the circuit design device according to the fourth embodiment.

### DETAILED DESCRIPTION

In general, according to one embodiment, a circuit design device includes a classification unit and a generation unit. The classification unit is configured to classify a plurality of wires included in a circuit into a first wire group that includes at least one first wire and a second wire group that includes at least one second wire based on toggle rates of the plurality of wires. The generation unit is configured to generate, based on first information indicating a layout of the plurality of wires on a substrate, second information indicating a layout of the plurality of wires on the substrate and a first dummy wire, the first dummy wire being arranged in a first region within a first range from the first wire.

Hereinafter, embodiments will be described with reference to the drawings. In the descriptions below, constituent elements having the same functions and configurations will be denoted by the same reference symbols.

### 1. First Embodiment

A circuit design device according to a first embodiment will be described. The circuit design device according to the first embodiment is applied to, for example, a technique of inserting dummy metal when a semiconductor chip such as a large-scale integrated circuit (LSI), etc. is designed, while an increase in power consumption is suppressed. For example, an increase in power consumption due to dummy metal is suppressed by the circuit design device according to the first embodiment.

In the following descriptions, the term “dummy metal” refers to a conductor not electrically coupled to any elements of various kinds and terminals in a semiconductor chip and not functioning as a circuit. The term “net” refers to a conductor electrically coupled to any elements of various kinds in a semiconductor chip and functioning as a circuit, or a node on a circuit corresponding to the conductor. In the following, the terms “net” and “dummy metal” may be referred to as “wire” and “dummy wire”, respectively.

1.1 Configuration

First, the configuration of the circuit design device according to the first embodiment will be described.

1.1.1 Hardware Configuration

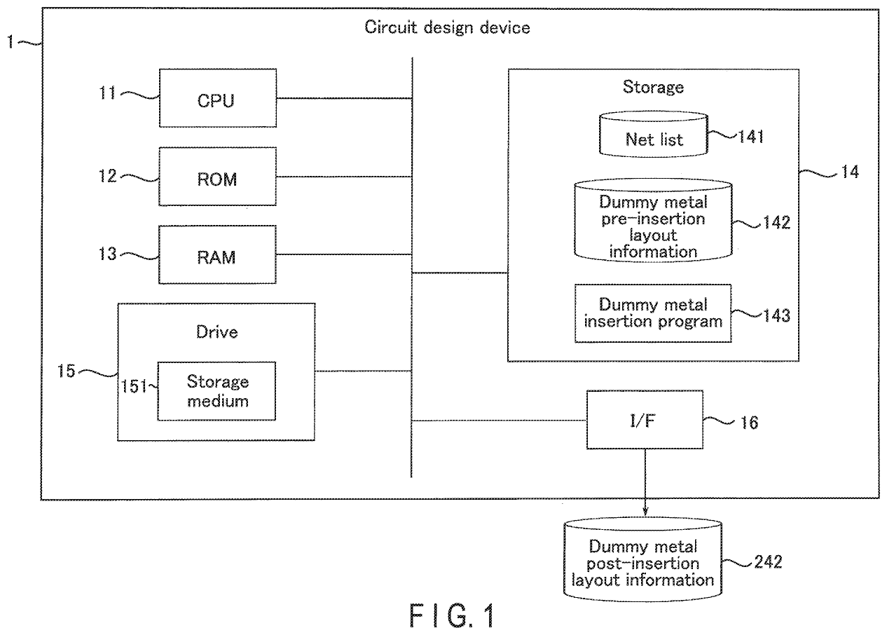

A hardware configuration of the circuit design device according to the first embodiment will be described with reference to FIG. 1.

As shown in FIG. 1, the circuit design device 1 includes a central processing unit (CPU) 11, a read-only memory (ROM) 12, a random access memory (RAM) 13, and a storage 14, a drive 15, and an interface 16. The circuit design device 1 has a function of generating a layout by inserting, with priority, dummy metal fills into a region that does not have significant influence on power consumption, in a stage of designing a circuit of a semiconductor chip such as an LSI, etc.

The CPU 11 executes various processing programs stored in the ROM 12, and controls the operation of whole circuit design device 1, using the RAM 13 as a working space.

The storage 14 is an auxiliary storage apparatus, such as a hard disk drive (HDD) or a solid state drive (SSD). In the storage 14, a dummy metal insertion layout program 143 executed on the circuit design device 1 is stored. A net list 141 and dummy metal pre-insertion layout information 142, for example, are also stored in the storage 14 as input information necessary for executing the dummy metal insertion layout program 143.

The net list 141 is information regarding conductors (i.e., nets or wires) electrically coupling various elements (a logic gate such as an AND circuit and an exclusive OR circuit) provided on a semiconductor chip in order for the semiconductor chip to have a desired function. Properties of a signal communicated via each net, for example, are associated with a corresponding net, and stored in the net list 141.

The dummy metal pre-insertion layout information 142 is information indicating an arrangement (layout) of a plurality of wires corresponding to a plurality of nets on a substrate managed on the net list 141. In the dummy metal pre-insertion layout information 142, a layout relating to wires necessary for a semiconductor chip to have a desired function is stored, but layouts relating to dummy wires that do not contribute to functions of a semiconductor chip are not stored.

The dummy metal insertion layout program 143 is a program for causing the circuit design device 1 to execute dummy metal insertion processing. The dummy metal insertion processing includes processing of simulating insertion locations for a dummy metal that would satisfy a later-described condition and at the same time suppress an influence of the dummy metal on power consumption, and processing of generating dummy metal post-insertion layout information 242 as a result of the simulation. The dummy metal insertion layout program 143 may be stored on the ROM 12. The details of the dummy metal insertion layout program 143 will be described later.

The drive 15 is a drive, such as a compact disk (CD) drive or a digital versatile disk (DVD) drive, etc., and is a device for reading programs stored in the storage medium 151. A type of the drive 15 may be selected as appropriate in accordance with a type of the storage medium 151. The net list 141, the dummy metal pre-insertion layout information 142, and the dummy metal insertion layout program 143 may be stored in this storage medium 151.

The storage medium 151 is a medium storing information of programs recorded thereon in an electronic, magnetic, optical, mechanical, or chemical manner so that the information of programs is readable for a computer, device or machine.

The interface 16 is an interface that governs sending and receiving of information between the circuit design device 1 and an external device. The interface 16 includes an interface, such as a communication interface in which a wired or wireless communication scheme is adopted, a printer, a graphical user interface (GUI) having a display screen (e.g., a liquid crystal display (LCD), an electroluminescence (EL) display, and a cathode ray tube display, etc.), or the like. The interface 16 has a function of outputting the dummy metal post-insertion layout information 242 generated by the dummy metal insertion layout program 143 executed in the circuit design device 1, and presenting the information 242 to a user.

The dummy metal post-insertion layout information 242 is the dummy metal pre-insertion layout information 142 to which a layout of dummy metal is added.

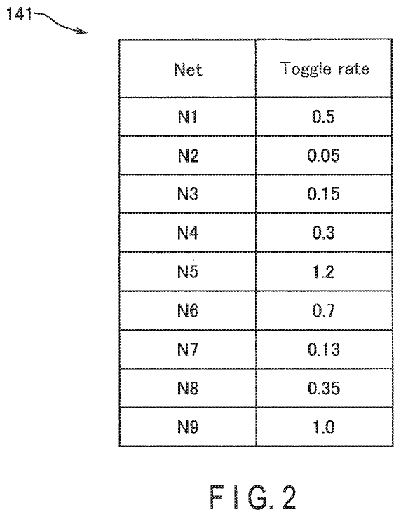

FIG. 2 is a conceptual drawing showing a specific example of the net list according to the first embodiment.

As shown in FIG. 2, the net list 141 is associated at least with a net and a toggle rate of a signal supplied to the net, for example.

The toggle rate is a specific example of information used for determining in the dummy metal insertion processing whether or not dummy metal is inserted. The toggle rate indicates an expected value of the number of signal inversions per cycle of a reference clock, for example. In other words, the larger the toggle rate is, the more frequently the signal inversion occurs.

FIG. 2 shows an example where nine nets N1, N2, N3, N4, N5, N6, N7, N8, and N9 are included in a semiconductor chip. Specifically, the toggle rate of the net N1 is 0.5; the toggle rate of the net N2 is 0.05; the toggle rate of the net N3 is 0.15; the toggle rate of the net N4 is 0.3; the toggle rate of the net N5 is 1.2; the toggle rate of the net N6 is 0.7; the toggle rate of the net N7 is 0.13; the toggle rate of the net N8 is 0.35; and the toggle rate of the net N9 is 1.0.

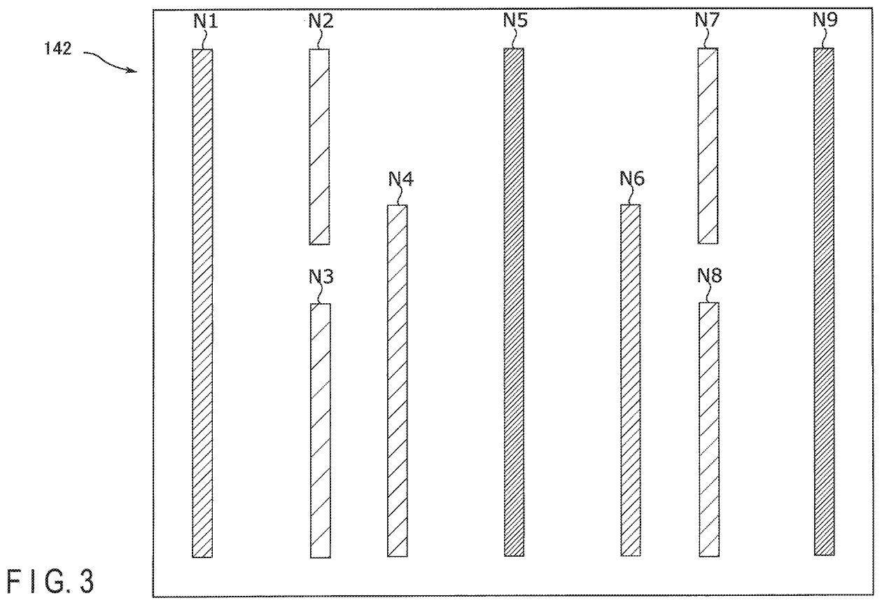

FIG. 3 is a schematic diagram showing a specific example of the dummy metal pre-insertion layout information according to the first embodiment.

As shown in FIG. 3, the dummy metal pre-insertion layout information 142 shows how the nets N1 to N9 in the net list 141 are arranged on a substrate, for example. Specifically, there is a region to which two wires or dummy wires can be inserted between the nets N1 and N2, and N1 and N3. There is a region to which one wire or dummy wire can be inserted between the nets N2 and N4, and N3 and N4. There is a region to which two wires or dummy wires can be inserted between the nets N4 and N5. There is a region to which four wires or dummy wires can be inserted between the nets N2 and N5. There is a region to which two wires or dummy wires can be inserted between the nets N5 and N6. There is a region to which one wire or dummy wire can be inserted between the nets N6 and N7, and N6 and N8. There is a region to which two wires or dummy wires can be inserted between the nets N7 and N9, and N8 and N9. There is a region to which four wires or dummy wires can be inserted between the nets N5 and N7.

In FIG. 3, of elements of various kinds and the wires formed on a substrate, only the wires are shown and the various elements are omitted. Furthermore, for the sake of explanation, the layout of the wires is visually displayed in FIG. 3; however, the format of the dummy metal pre-insertion layout information 142 is not limited to the above-described example. For example, in the dummy metal pre-insertion layout information 142, information indicating a two-dimensional or three-dimensional region on a substrate on which the wires are arranged may be indicated with the use of coordinates, etc., for example.

1.1.2 Functional Configuration

Next, a functional configuration of the circuit design device according to the first embodiment is described.

The CPU 11 of the circuit design device 1 loads the dummy metal insertion layout program 143 stored in the storage 14 into the RAM 13. Then, the CPU 11 interprets and executes the dummy metal insertion layout program 143 loaded on the RAM 13 and controls each of the constituent elements.

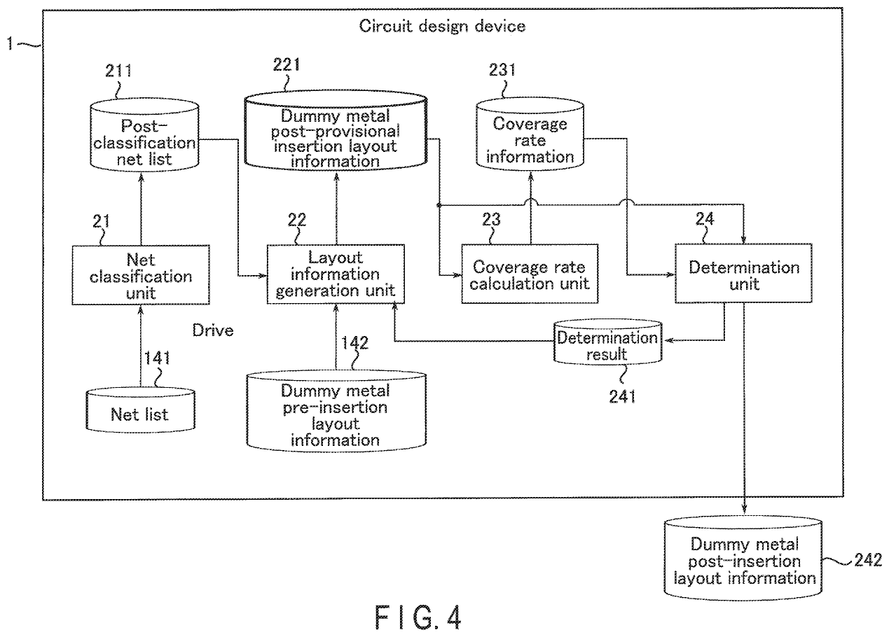

FIG. 4 is a block diagram for explaining a functional configuration of the circuit design device according to the first embodiment.

As shown in FIG. 4, when the dummy metal insertion processing is performed, the circuit design device 1 functions as a computer having a net classification unit 21, a layout information generation unit 22, a coverage rate calculation unit 23, and a determination unit 24. When the dummy metal insertion processing is performed, courtesy of the above-described function units 21 through 24, the circuit design device 1 functions as a computer that generates, as intermediate products, a post-classification net list 211, dummy metal post-provisional insertion layout information 221, coverage rate information 231, and a determination result 241, and ultimately outputs the dummy metal post-insertion layout information 242.

The net classification unit 21 reads the net list 141 from the storage 14, and classifies all the nets in the net list 141 into groups in accordance with a predetermined algorithm. Specifically, for example, the net classification unit 21 classifies the nets having close toggle rates into one group. The range of toggle rates classified by one group and the number of classification groups can be determined as appropriate. The net list 141 classified into the groups by the net classification unit 21 is sent to the layout information generator 22 as the post-classification net list 211.

Upon receipt of the post-classification net list 211, the layout information generation unit 22 reads the dummy metal pre-insertion layout information 142 from the storage 14, and performs simulation for arranging dummy metal appropriately. In the simulation, it is determined whether or not dummy metal is inserted around the nets for each group as classified in the post-classification net list 211. Thus, the layout information generation unit 22 generates the dummy metal post-provisional insertion layout information 221 that represents a dummy metal pattern in which dummy metal is provisionally inserted in a pattern corresponding to the dummy metal pre-insertion layout information 142. The generated dummy metal post-provisional insertion layout information 221 is sent to the coverage rate calculation unit 23 and the determination unit 24.

The layout information generation unit 22 receives the dummy metal post-provisional insertion layout information 221 as a determination result 241 from the determination unit 24. The layout information generation unit 22 further performs simulation for additionally arranging dummy metal based on the determination result 241. Thus, the layout information generation unit 22 can generate the dummy metal post-provisional insertion layout information 221 representing a pattern in which more dummy metal fills are arranged than in a pattern corresponding to the previously generated dummy metal post-provisional insertion layout information 221.

Upon receipt of the dummy metal post-provisional insertion layout information 221, the coverage rate calculation unit 23 calculates a coverage rate of the wires and the dummy wires in a semiconductor chip based on the layout information. The coverage rate means a rate of an area of wires and the dummy wires with respect to a whole area parallel to a substrate (in other words, a rate of an area of wires and the dummy wires with respect to a surface area of a substrate). The coverage rate calculation unit 23 calculates the coverage rate for each stack that includes a plurality of layers arranged on the substrate. The coverage rates calculated for all the layers are sent to the determination unit 24 as the coverage rate information 231.

Upon receipt of the dummy metal post-provisional insertion layout information 221, and the coverage rate information 231 corresponding thereto, the determination unit 24 determines whether or not the inserted dummy metal fills satisfy a predetermined condition based on the coverage rate information 231. If it is determined that the predetermined condition is not satisfied, the determination unit 24 returns the dummy metal post-provisional insertion layout information 221 to the layout information generation unit 22 as the determination result 241. If it is determined that the predetermined condition is satisfied, the determination unit 24 outputs the dummy metal post-provisional insertion layout information 221 as the dummy metal post-insertion layout information 242, and presents it to a user.

The circuit design device 1 having the above-described functional configuration can perform the dummy metal insertion processing.

1.2 Operation

Next, the operation of the circuit design device according to the first embodiment will be described.

1.2.1 Flowchart of Dummy Metal Insertion Processing

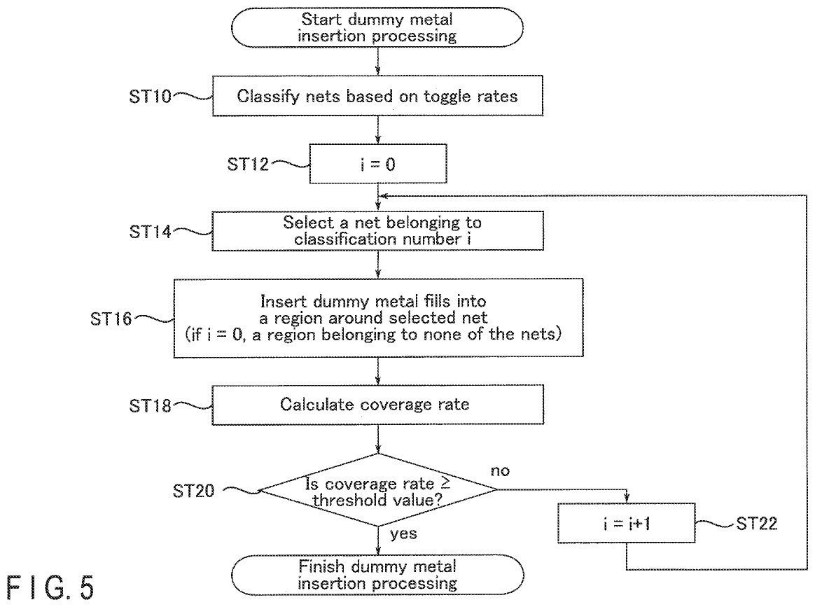

First, the dummy metal insertion processing in the circuit design device according to the first embodiment will be described with reference to the flowchart of FIG. 5. The circuit design device 1 functions as the net classification unit 21 in step ST10 shown in FIG. 5, as the layout information generation unit 22 in steps ST12, ST14, ST16, and ST22, as the coverage rate calculation unit 23 in step ST18, and as the determination unit 24 in step ST20.

As shown in FIG. 5, in step ST10, the net classification unit 21 sorts all the nets in the net list 141 based on the toggle rates, and classifies the nets in accordance with a predetermined range of the toggle rates. In the post-classification net list 211 generated in this processing, each net belongs to any one of a predetermined number of groups. In the descriptions hereinafter, classification numbers (1, 2 . . . ) are assigned to the groups so as to uniquely identify the groups, and a group with a smaller classification number is a group of nets having smaller toggle rates.

In step ST12, the layout information generation unit 22 receives the post-classification net list 211 generated in step ST10, and sets the variable i to “0” (i is an integer equal to or greater than 0).

In step ST14, the layout information generation unit 22 selects a net belonging to a group corresponding to a classification number i. If i=0, there is no group corresponding to the classification number 0; in this case, the layout information generation unit 22 does not select any of the nets.

In step ST16, the layout information generation unit 22 inserts dummy metal fills into a region around the net selected in step ST14. Herein, the region “around” the net means a region in the vicinity of a target net. A boundary between the region “around” the net and its peripheral region may be defined by a distance between the net and the boundary. The distance from the net that defines the region “around” the net may be set to a predetermined distance, for example. If i=0, the layout information generation unit 22 inserts dummy metal fills into a region belonging to none of the nets (in other words, a region separate from any of the nets).

Thus, the layout information generation unit 22 generates the dummy metal post-provisional insertion layout information 221.

In step ST18, the coverage rate calculation unit 23 calculates a coverage rate for each layer on the substrate based on the dummy metal post-provisional insertion layout information 221, and generates the coverage rate information 231.

In step ST20, the determination unit 24 determines, for each of the layers, whether or not the coverage rate satisfies a predetermined condition based on the coverage rate information 231. Specifically, the determination unit 24 determines, for each of the layers, whether or not the coverage rate is equal to or greater than a threshold value.

If it is determined that there is even one layer having a coverage rate not equal to or greater than a threshold value (No in step ST20), the determination unit 24 returns the dummy metal post-provisional insertion layout information 221 to which the determination is made to the layout information generation unit 22 as a determination result 241, and the processing proceeds to step ST22. In step ST22, the layout information generation unit 22 increments the variable i, and the processing returns to step ST14. In steps ST14, ST16, and ST18 after step ST22, dummy metal fills are inserted around the nets belonging to a group of nets having larger toggle rates, as the variable i has been incremented. Thus, in the process of determining a coverage rate in step ST20, the process of additionally inserting dummy metal fills is repeated until the coverage rates of all the layers are determined to be equal to or greater than the threshold value.

If it is determined that the coverage rates of all the layers are equal to or greater than the threshold value (Yes in step ST20), the determination unit 24 outputs the dummy metal post-provisional insertion layout information 221 to which the determination is made as the dummy metal post-insertion layout information 242, and presents it to a user.

The dummy metal insertion processing is thus finished.

1.2.2 Specific Example of Dummy Metal Insertion Processing

Next, a specific example of the dummy metal insertion processing according to the first embodiment will be schematically described.

In the following, as an example, a case where the net list 141 shown in FIG. 2 and the dummy metal pre-insertion layout information 142 shown in FIG. 3 are applied to the foregoing dummy metal insertion processing will be described. Suppose the region “around” a net is a region into which one wire or dummy wire having a smallest width (hereinafter, simply referred to as “wire or dummy wire”) can be inserted among the regions in the vicinity of the net. Furthermore, suppose 20 percent is set as a threshold value for the coverage rate.

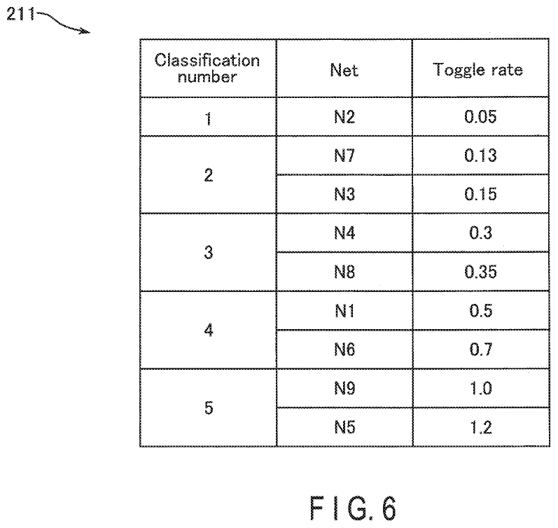

FIG. 6 is a conceptual drawing for explaining the post-classification net list according to the first embodiment.

As shown in FIG. 6, in the post-classification net list 211, the nets N1 to N9 are classified into any one of the classification numbers 1 to 5, in accordance with the values of the toggle rates.

For example, in the example of FIG. 6, a net having a toggle rate smaller than 0.1 is classified into the classification number 1; a net having a toggle rate equal to or greater than 0.1 and smaller than 0.2 is classified into the classification number 2; a net having a toggle rate equal to or greater than 0.2 and smaller than 0.4 is classified into the classification number 3; a net having a toggle rate equal to or greater than 0.4 and smaller than 0.8 is classified into the classification number 4; and a net having a toggle rate equal to or greater than 0.8 is classified into the classification number 5. According to such a classification, of the nets N1 to N9, the net N2 is classified into the classification number 1, the nets N7 and N3 into the classification number 2, the nets N4 and N8 into the classification number 3, the nets N1 and N6 into the classification number 4, and the nets N9 and N5 into the classification number 5.

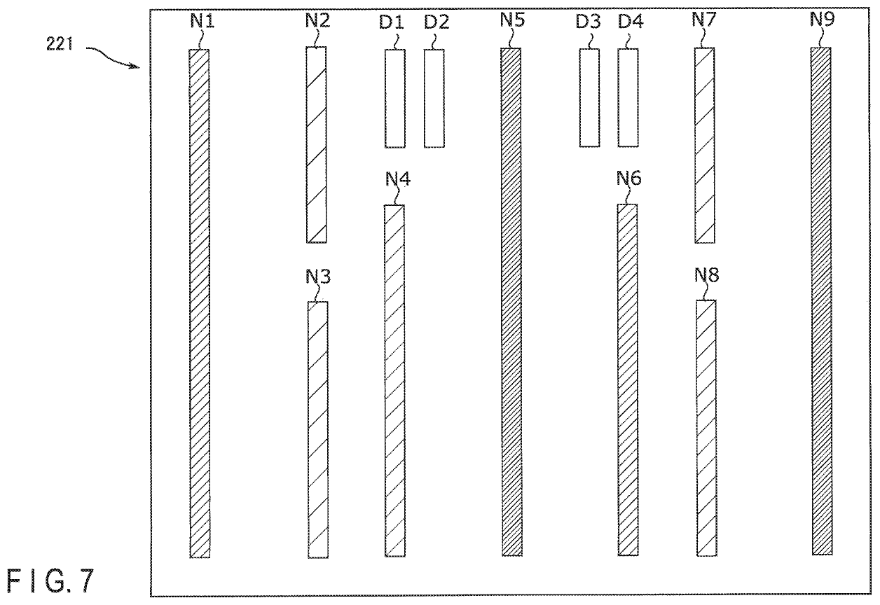

FIGS. 7, 8, and 9 are schematic diagrams for explaining the dummy metal post-provisional insertion layout information according to the first embodiment. Specifically, FIGS. 7, 8, and 9 respectively correspond to the dummy metal post-provisional insertion layout information 221 generated in step ST16 shown in FIG. 5, when i=0, 1, 2.

As shown in FIG. 7, when i=0, the layout information generation unit 22 inserts dummy metal fills D1, D2, D3, and D4 further into a region separate from any of the nets N1 to N9 than a width that allows insertion of one wire or dummy wire.

Specifically, dummy metal fills D1 and D2 are respectively inserted into, among the regions located between the nets N2 and N5 that allow insertion of four wires or dummy wires, the second region from the net N2 (the third region from the net N5) and the third region from the net N2 (the second region from the net N5), in the area above the net N4 in the diagram. Dummy metal fills D3 and D4 are respectively inserted into, among the regions located between the nets N5 and N7 that allow insertion of four wires or dummy wires, the second region from the net N5 (the third region from the net N7) and the third region from the net N5 (the second region from the net N7), in the area above the net N6 in the diagram.

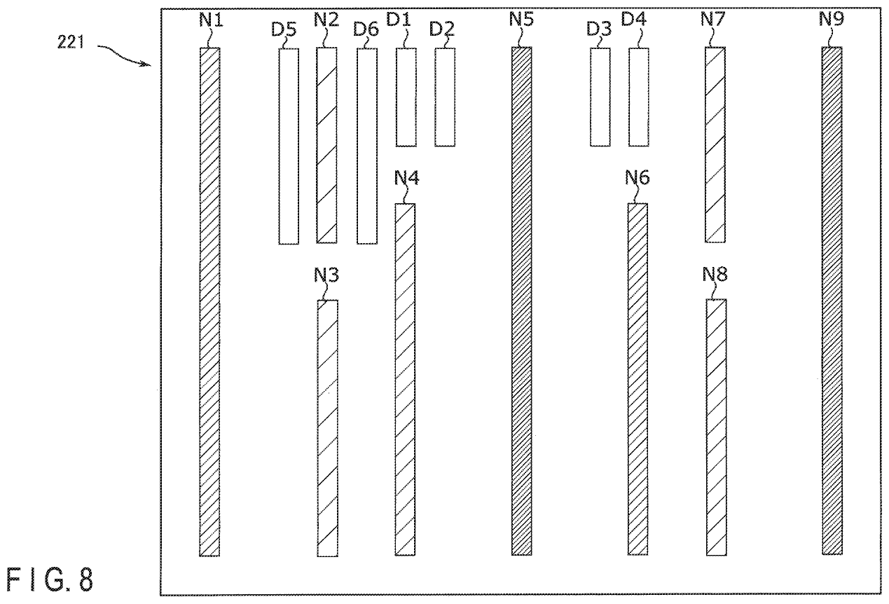

The coverage rates based on the dummy metal post-provisional insertion layout information 221 shown in FIG. 7 do not reach the threshold value, for example. For this reason, the variable i is incremented from “0” to “1”, and the dummy metal post-provisional insertion layout information 221 shown in FIG. 8 is generated.

As shown in FIG. 8, if i=1, the layout information generation unit 22 inserts dummy metal fills D5 and D6 into the regions one wire (or dummy wire) away from the net N2 belonging to the classification number 1.

Specifically, the dummy metal fill D5 is inserted, along the net N2, into a second region from the net N1 (the first region from the net N2) among the regions that allow insertion of two wires or dummy wires between the nets N1 and N2. The dummy metal fill D6 is inserted, along the net N2, into a region between the nets N2 and N4 one wire (or dummy wire) away from the nets N2 and N4.

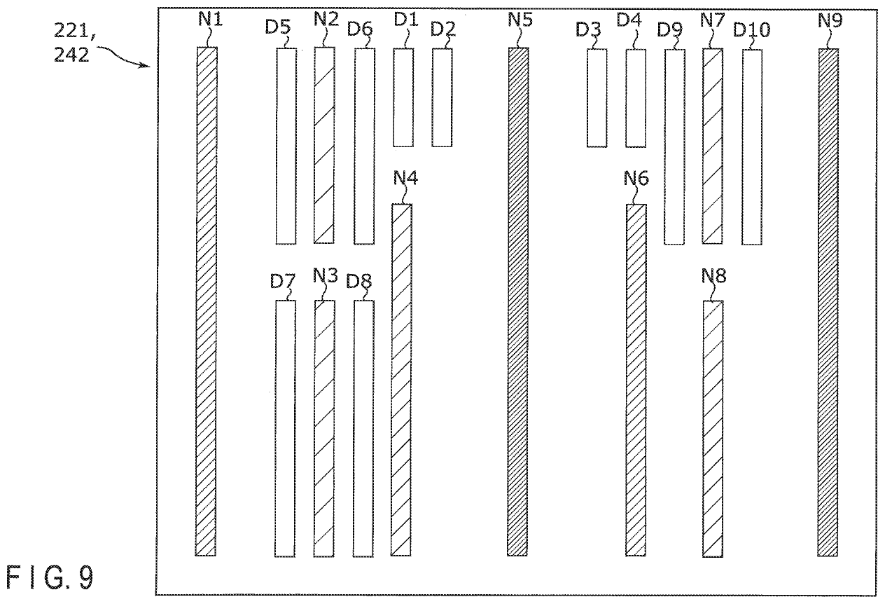

The coverage rates based on the dummy metal post-provisional insertion layout information 221 shown in FIG. 8 do not reach the threshold value, for example. For this reason, the variable i is incremented from “1” to “2”, and the dummy metal post-provisional insertion layout information 221 shown in FIG. 9 is generated.

As shown in FIG. 9, if i=2, the layout information generation unit 22 inserts, for the nets N3 and N7 belonging to the classification number 2, dummy metal fills D7 and D8 into a region one wire or dummy wire away from the net N3, and dummy metal fills D9 and D10 into a region one wire or dummy wire away from the net N7.

Specifically, the dummy metal fill D7 is inserted, along the net N3, into the second region from the net N1 (the first region from the net N3) among the regions that allow insertion of two wires or dummy wires between the nets N1 and N3. The dummy metal fill D8 is inserted, along the net N3, into a region between the nets N3 and N4 one wire or dummy wire away from the nets N3 and N4. The dummy metal fill D9 is inserted, along the net N7, into a region between the nets N6 and N7 one wire or dummy wire away from the nets N6 and N7. The dummy metal fill D10 is inserted into, along the net N7, the first region from the net N7 (the second region from the net N9), among the regions located between the nets N7 and N9 that allow insertion of two wires or dummy wires.

The coverage rates based on the dummy metal post-provisional insertion layout information 221 shown in FIG. 9 reach the threshold value, for example. For this reason, the determination unit 24 outputs the dummy metal post-provisional insertion layout information 221 shown in FIG. 9 as the dummy metal post-insertion layout information 242.

1.3 Advantageous Effects of First Embodiment

According to the first embodiment, it is possible to insert dummy metal while an increase in power consumption is suppressed. This advantageous effect will be described below.

The net classification unit 21 classifies a plurality of nets N1 to N9 included in the net list 141 into a plurality of groups in accordance with the values of toggle rates. The layout information generation unit 22 inserts, with priority, dummy metal fills into a region around nets belonging to a group of nets having small toggle rates based on the dummy metal pre-insertion layout information 142, and generates dummy metal post-provisional insertion layout information 221. It is thereby possible to insert more dummy metal fills around a net having a small toggle rate than in a case where dummy metal fills are evenly inserted regardless of large or small toggle rates, and to avoid inserting dummy metal fills around a net having a large toggle rate. It is thus possible to suppress an increase of power consumption in a circuit due to dummy metal.

To explain, power consumption in a net is proportional to a toggle rate and a parasitic capacitance. This is because a change in level of a signal communicated via a net causes charging and discharging of a parasitic capacitance of a net. For this reason, an amount of power consumed in a net, W, can be formulated, for example W=½×fCV². Herein, f is the toggle rate, C is the parasitic capacitance, and V is the voltage. The dummy metal fills arranged around a net increase a parasitic capacitance of the net. For this reason, if dummy metal fills are arranged around a net having a large toggle rate, power consumption becomes larger than in a case where dummy metal fills are arranged around a net having a small toggle rate.

According to the first embodiment, dummy metal fills are inserted around nets having small toggle rates with priority. For this reason, an increase in parasitic capacitance of a net having a large toggle rate can be suppressed, and an increase in power consumption can be suppressed.

### 2. Second Embodiment

Next, a circuit design device according to a second embodiment is described.

In the first embodiment, dummy metal is inserted into a region around a net in the order of the toggle rates of the nets, from the smallest to the largest. The second embodiment differs from the first embodiment in that blockages are set over whole regions in which the nets are arranged and blockages are canceled one at a time from among the blockage around the net having a small toggle rate, and then dummy metal is inserted into the region for which the blockage has been canceled. In the following descriptions, descriptions of configurations and operations similar to those of the first embodiment will be omitted, and differences from the first embodiment will primarily be described.

2.1 Flowchart of Dummy Metal Insertion Processing

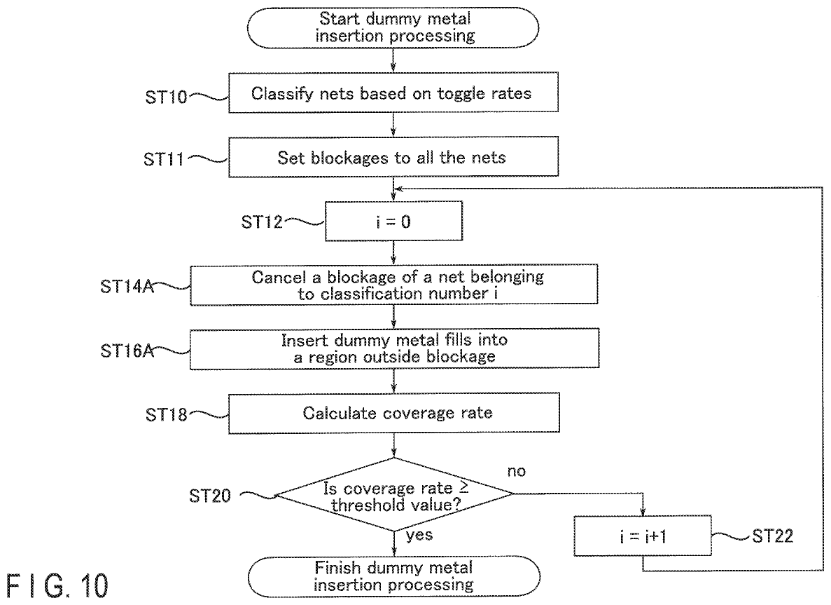

FIG. 10 is a flowchart for explaining the dummy metal insertion processing in the circuit design device according to the second embodiment, and corresponds to FIG. 5 of the first embodiment. The circuit design device 1 performs steps ST14A and ST16A instead of steps ST14 and ST16 shown in FIG. 5, and further performs step ST11. The circuit design device 1 functions as the layout information generation unit 22 in steps ST14A and ST16A shown in FIG. 10.

As shown in FIG. 10, in step ST10, the net classification unit 21 sorts all the nets in the net list 141 based on the toggle rates, and classifies the nets in accordance with a predetermined range of the toggle rates. The processing is the same as the processing in step ST10 shown in FIG. 5 of the first embodiment.

In step ST11, the layout information generation unit 22 sets a blockage to each of the nets for the dummy metal pre-insertion layout information 142. The range where the blockage is set may be the same as the range meant by “around the net” in the first embodiment.

In step ST12, the layout information generation unit 22 sets a variable i to “0” (i is an integer equal to or greater than 0).

In step ST14A, the layout information generation unit 22 cancels the blockage of a net belonging to the group corresponding to the classification number i. If i=0, there is no group corresponding to the classification number 0; accordingly, the layout information generation unit 22 does not cancel any of the blockages of the nets.

In step ST16A, the layout information generation unit 22 inserts dummy metal fills into a region outside a blockage not canceled in step ST14A (namely, a region where no blockage is present). Thus, the layout information generation unit 22 generates the dummy metal post-provisional insertion layout information 221.

Since steps ST18, ST20, and ST22 hereafter are the same as steps ST18, ST20, and ST22 shown in FIG. 5 of the first embodiment, descriptions of the steps are omitted.

The dummy metal insertion processing is thus finished.

2.2 Specific Example of Dummy Metal Insertion Processing

Next, a specific example of the dummy metal insertion processing according to the second embodiment will be schematically described. Suppose a blockage of a net is set in a region that allows insertion of one wire, among the regions in the vicinity of the net.

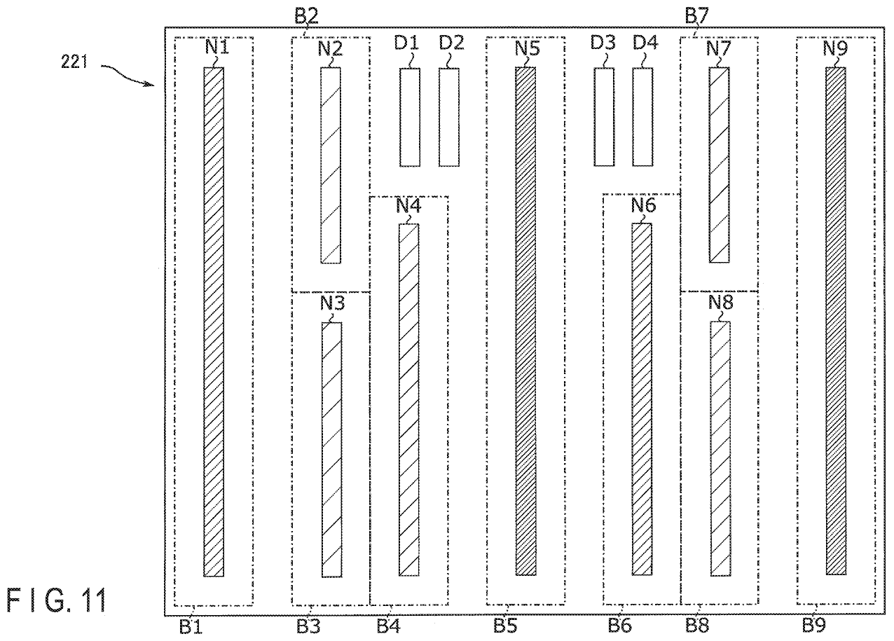

FIGS. 11, 12, and 13 are schematic diagrams for explaining dummy metal post-provisional insertion layout information according to the second embodiment. Specifically, FIGS. 11, 12, and 13 correspond to the dummy metal post-provisional insertion layout information 221 generated in step ST16A shown in FIG. 10, when i=0, 1, 2.

As shown in FIG. 11, if i=0, the layout information generation unit 22 sets blockages B1 to B9 to all the nets N1 to N9, respectively. Then, the layout information generation unit 22 inserts dummy metal fills D1, D2, D3, and D4 into regions outside the blockages B1 to B9. Herein, since the dummy metal fills D1 to D4 shown in FIG. 11 have the same layout as the dummy metal fills D1 to D4 shown in FIG. 6, descriptions are omitted. Depending on the net list 141 and the dummy metal pre-insertion layout information 142 in consideration, the layout of dummy metal to be inserted when i=0 may be different between the first embodiment and the second embodiment.

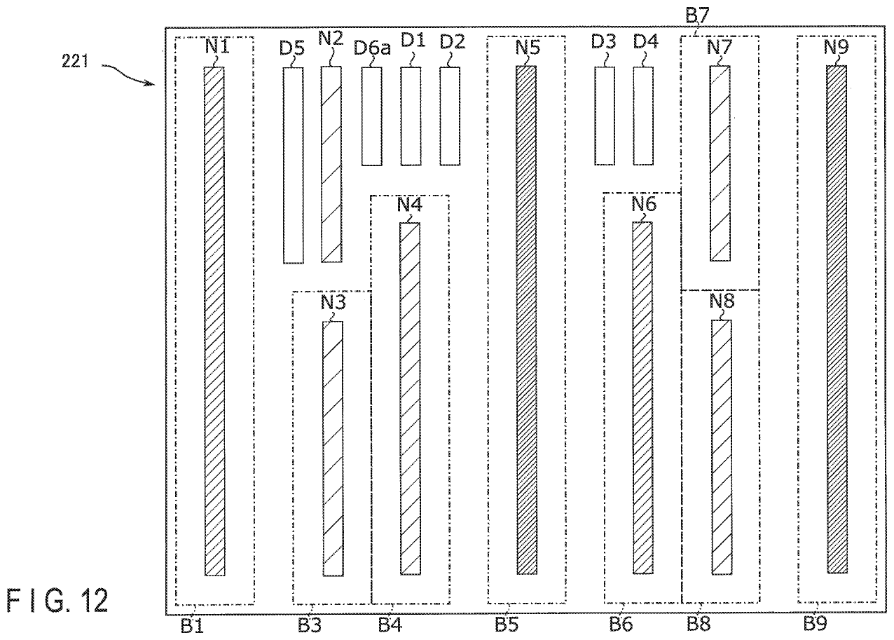

The coverage rates based on the dummy metal post-provisional insertion layout information 221 shown in FIG. 11 do not reach the threshold value, for example. For this reason, the variable i is incremented from “0” to “1”, and the dummy metal post-provisional insertion layout information 221 shown in FIG. 12 is generated.

As shown in FIG. 12, if i=1, the layout information generation unit 22 inserts dummy metal fills D5 and D6a into the regions outside the blockages B1 and B3 through B9, after canceling the blockage B2 of the net N2 belonging to the classification number 1.

Specifically, the dummy metal fill D5 is inserted, along the net N2, into the second region from the net N1 (the first region from the net N2) among the regions that allow insertion of two wires or dummy wires between the nets N1 and N2. The dummy metal fill D6a is inserted into, along the net N2, a region between the net N2 and the dummy metal fill D1 one wire or dummy wire away from the net N2 and the dummy metal fill D1, in the area above the blockage B4 in the diagram.

Thus, the blockage B2 of the net N2 is canceled but the blockage B4 of the net N4 remains set. For this reason, among the regions located between the nets N2 and N4, no dummy metal is inserted into the region within the blockage B4.

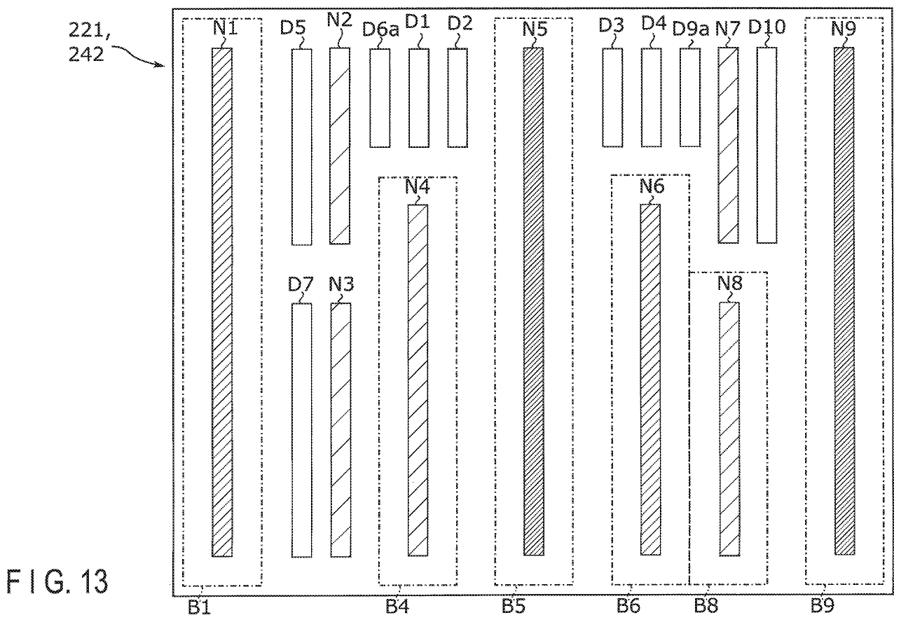

The coverage rates based on the dummy metal post-provisional insertion layout information 221 shown in FIG. 12 do not reach the threshold value, for example. For this reason, the variable i is incremented from “1” to “2”, and the dummy metal post-provisional insertion layout information 221 shown in FIG. 13 is generated.

As shown in FIG. 13, if i=2, the layout information generation unit 22 inserts dummy metal fills D7, D9a, and D10 into the regions outside the blockages B1, B4 to B6, B8, and B9, after canceling the blockage B3 of the net N3 and the blockage B7 of the net N7 both belonging to the classification number 2.

Specifically, the dummy metal fill D7 is inserted, along the net N3, into the second region from the net N1 (the first region from the net N3) among the regions that allow insertion of two wires or dummy wires between the nets N1 and N3. The dummy metal fill D9a is inserted, along the net N7, into a region between the dummy metal fill D4 and the net N7 one wire or dummy wire away from the dummy metal fill D4 and the net N7, in the area above the blockage B6 in the diagram. The dummy metal fill D10 is inserted, along the net N7, into the first region from the net N7 (the second region from the net N9), among the regions that allow insertion of two wires or dummy wires between the nets N7 and N9.

Thus, the blockage B3 of the net N3 is canceled but the blockage B4 of the net N4 remains set. For this reason, among the regions located between the nets N3 and N4, dummy metal is not inserted into the region within the blockage B4. Thus, the blockage B7 of the net N7 is canceled but the blockage B6 of the net N6 remains set. For this reason, among the regions located between the nets N6 and N7, dummy metal is not inserted into the region within the blockage B6.

The coverage rates based on the dummy metal post-provisional insertion layout information 221 shown in FIG. 13 reach the threshold value, for example. For this reason, the determination unit 24 outputs the dummy metal post-provisional insertion layout information 221 shown in FIG. 13 as the dummy metal post-insertion layout information 242.

2.3 Advantageous Effects of Second Embodiment

According to the second embodiment, the layout information generation unit 22 cancels a blockage set around a net in a group having small toggle rates in the order the smallest to the largest toggle rates, and inserts dummy metal fills with priority into the region where the blockage is canceled. Thus, dummy metal fills are not inserted into a region for which a blockage is still set, even if the region is around a net belonging to a group of small toggle rates. For this reason, it is possible to avoid inserting dummy metal into a region that contributes significantly to the increase in power consumption.

### 3. Third Embodiment

Next, a circuit design device according to a third embodiment is described.

In the second embodiment, the example where a fixed value is uniformly applied to all the nets as a distance (the range of blockage) from the net defined so as to prohibit insertion of dummy metal into a region in the vicinity of the net, is described. The third embodiment differs from the second embodiment in that a different value is applied to a blockage range for each net or classification number. In the following descriptions, descriptions of the configuration and operation similar to those of the second embodiment will be omitted, and those differing from the second embodiment will primarily be described.

3.1 Specific Example of Dummy Metal Insertion Processing

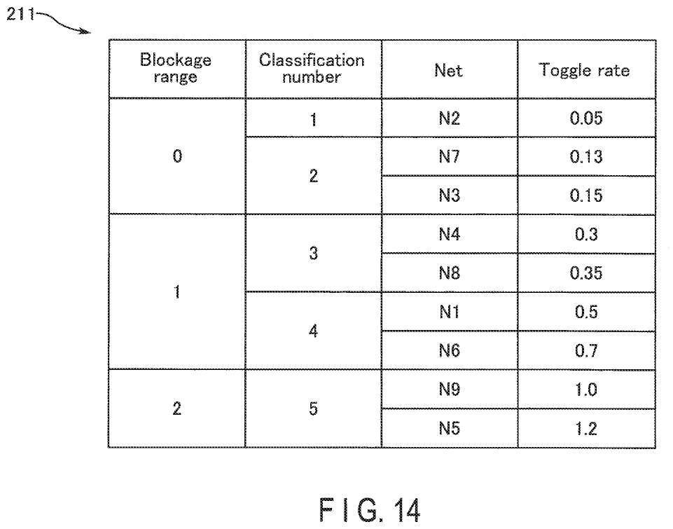

FIG. 14 is a conceptual drawing for explaining the post-classification net list according to the third embodiment.

As shown in FIG. 14, in the post-classification net list 211, the nets N1 to N9 stored in the net list 141 are classified into any one of the classification numbers 1 to 5 and any one of blockage ranges 0 to 2, in accordance with the value of the toggle rate. Specifically, for example, the nets N2, N7, and N3 classified into the classification number 1 or 2 are classified into the blockage range 0, and the nets N4, N8, N1, and N6 classified into the classification number 3 or 4 are classified into the blockage range 1, and the nets N9 and N5 classified into the classification number 5 is classified into the blockage range 2.

The blockage range corresponds to a distance from a target net in which dummy metal insertion is prohibited. For example, a blockage is not set for a net classified into the blockage range 0. For a net classified into the blockage range 1, a blockage that prohibits insertion of dummy metal into a region that allows insertion of one wire or dummy wire is set. For a net classified into the blockage range 2, a blockage that prohibits insertion of dummy metal into a region that allows insertion of two wires or dummy wires is set.

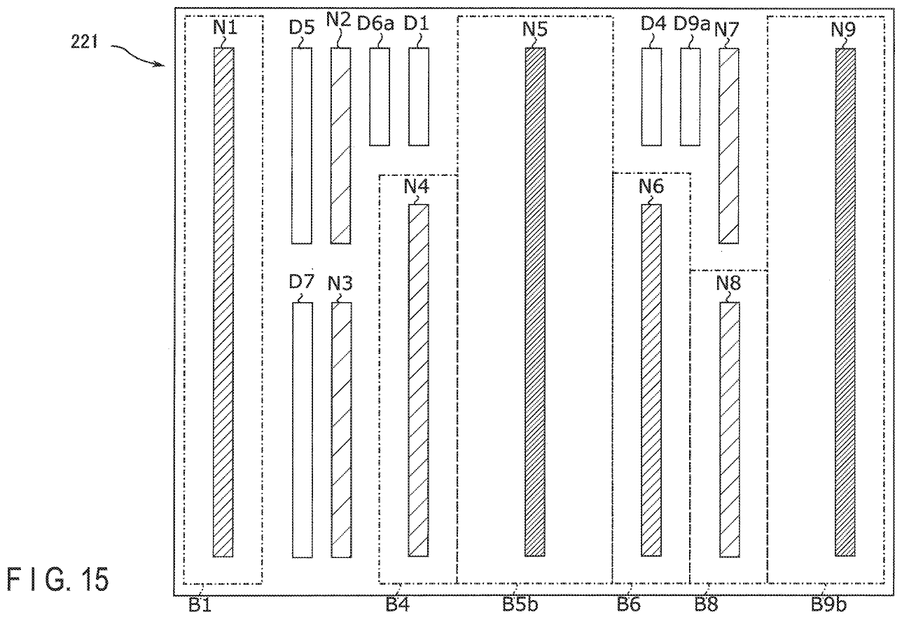

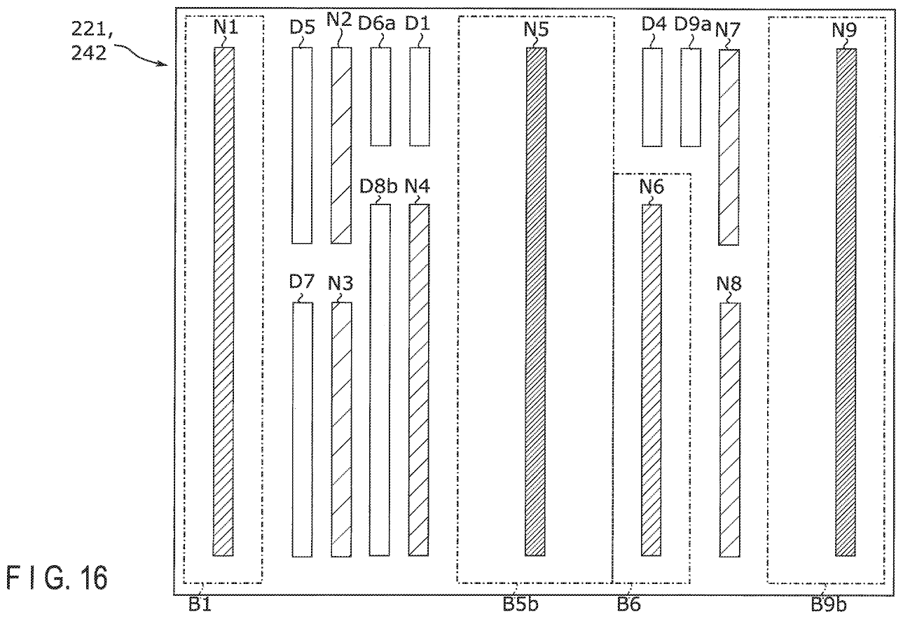

FIGS. 15 and 16 are schematic diagrams for explaining dummy metal post-provisional insertion layout information according to the third embodiment. Specifically, FIGS. 15 and 16 correspond to the dummy metal post-provisional insertion layout information 221 generated in step ST16 shown in FIG. 5, if i=0 to 2, and 3, respectively.

As shown in FIG. 15, if i=0, the layout information generation unit 22 sets blockages to all the nets N1 to N9, respectively. Herein, no blockages are substantially set to the nets N2, N3, and N7, as the blockage range of these nets is set to 0. As for the nets N1, N4, N6, and N8, the blockage range 1 is set thereto; accordingly, the blockages B1, B4, B6, and B8 that prohibit insertion of dummy metal are set to the regions equivalent to those of the blockages B1, B4, B6, and B8 shown in FIG. 11 of the second embodiment. Since the blockage range is set at 2 for the nets N5 and N9, the blockages B5b and B9b that prohibit insertion of dummy metal are set in regions one wire wider than the blockages B5 and B9 shown in FIG. 11 of the second embodiment.

Then, the layout information generation unit 22 inserts dummy metal fills D1, D4, D5, D6a, D7, and D9a into regions outside the blockages B1, B4, B5b, B6, B8, and B9b. Herein, since the dummy metal fills D1, D4, D5, D6a, D7, and D9a shown in FIG. 15 have the same layout as the dummy metal fills D1, D4, D5, D6a, D7, and D9a shown in FIG. 13 of the second embodiment, descriptions are omitted. The region into which the dummy metal fills D2 and D3 are inserted in FIG. 13 of the second embodiment is within the blockage B5b, and the region into which the dummy metal fill D10 is inserted is within the blockage B9b; therefore, the dummy metal fills D2 and D3 are not inserted in the example of FIG. 15.

The coverage rates based on the dummy metal post-provisional insertion layout information 221 shown in FIG. 15 do not reach the threshold value, for example. For this reason, the variable i is incremented from “0” to “3” until substantially a new blockage is canceled, and the dummy metal post-provisional insertion layout information 221 shown in FIG. 16 is generated.

As shown in FIG. 16, if i=3, the layout information generation unit 22 inserts dummy metal fill D8b into the regions outside the blockages B1, B5b, B6, and B9b, after canceling the blockage B4 of the net N4 and the blockage B8 of the net N8 both belonging to the classification number 3.

Specifically, the dummy metal fill D8b is inserted, along the net N4, into a region between the nets N2 and N4, and a region between the nets N3 and N4. Since the regions between the nets N4 and N5, between N8 and N6, and between N8 and N9 are within the range of the blockages B5b, B6, and B9b, no dummy metal is inserted into these regions in the example shown in FIG. 16.

The coverage rates based on the dummy metal post-provisional insertion layout information 221 shown in FIG. 16 reach the threshold value, for example. For this reason, the determination unit 24 outputs the dummy metal post-provisional insertion layout information 221 shown in FIG. 16 as the dummy metal post-insertion layout information 242.

3.3 Advantageous Effects of Third Embodiment

As described above, power consumption is proportional to a product of a toggle rate and a parasitic capacitance. An increase in a parasitic capacitance of a net due to dummy metal is inversely proportional to a distance between a net and dummy metal. For this reason, for example, an increase in power due to the insertion of dummy metal into a location a distance of “2” away from the net N9 having the toggle rate of 1.0, and an increase in power due to the insertion of dummy metal into a location a distance of “1” away from the net N1 having the toggle rate of 0.5 may be a similar amount. Accordingly, from a viewpoint of suppressing power consumption, it is preferable to set a larger region where dummy metal insertion is prohibited for a region around a net having a large toggle rate than for a region around a net having a small toggle rate.

According to the third embodiment, the net classification unit 21 makes the blockage range set to a net belonging to a group of the nets having large toggle rates larger than the blockage range set to a net belonging to a group of the nets having small toggle rates. Thus, it is possible to avoid inserting dummy metal into a region that highly contributes to an increase in power consumption.

### 4. Fourth Embodiment

Next, a circuit design device according to a fourth embodiment is described.

In the first to third embodiments, the cases where the nets are classified in accordance with the toggle rates are described. The fourth embodiment differs from the first to third embodiments in that the nets are classified based on other parameters that may contribute to an increase in power consumption, in addition to the toggle rates. In the following descriptions, descriptions of configuration and operation similar to those of the first embodiment will be omitted, and differences from the first embodiment will primarily be described.

4.1 Functional Configuration of Circuit Design Device

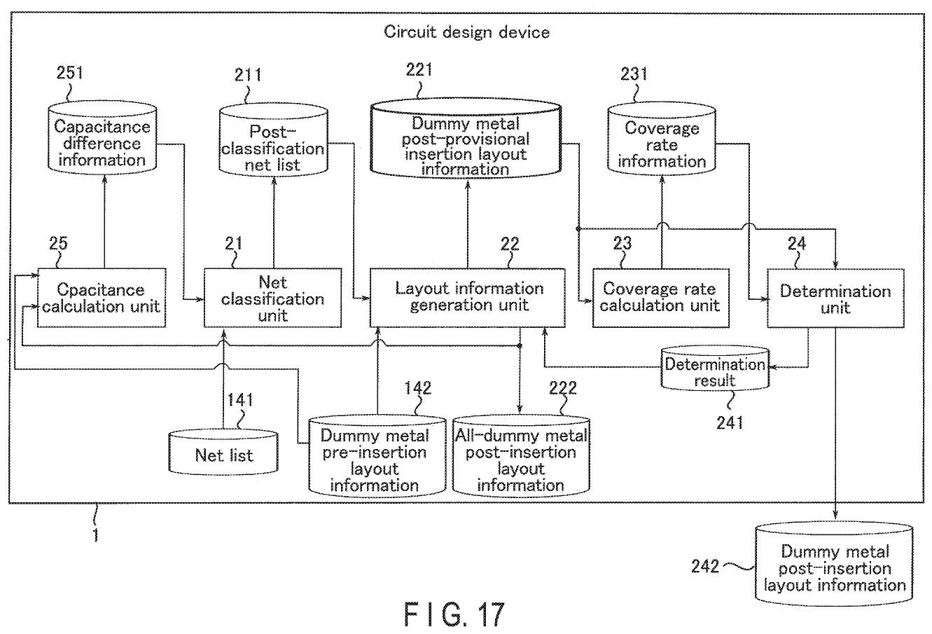

FIG. 17 is a block diagram for explaining a functional configuration of the circuit design device according to the fourth embodiment, and corresponds to FIG. 4 of the first embodiment.

As shown in FIG. 17, when the dummy metal insertion processing is performed, the circuit design device 1 functions as a computer further having a capacitance calculation unit 25, in addition to the net classification unit 21, the layout information generation unit 22, the coverage rate calculation unit 23, and the determination unit 24. When the dummy metal insertion processing is performed, courtesy of the above-described function units 21 through 25, the circuit design device 1 functions as a computer that generates, as intermediate products, all-dummy metal post-provisional insertion layout information 222 and the capacitance difference information 251, in addition to a post-classification net list 211, dummy metal post-provisional insertion layout information 221, coverage rate information 231, and a determination result 241, and ultimately outputs the dummy metal post-insertion layout information 242.

The layout information generation unit 22 reads the dummy metal pre-insertion layout information 142 from the storage 14, and generates all-dummy metal post-provisional insertion layout information 222 representing a pattern in which all the insertable dummy metal fills are inserted in a pattern represented by the dummy metal pre-insertion layout information 142. The generated all-dummy metal post-provisional insertion layout information 222 is sent the capacitance calculation unit 25.

The capacitance calculation unit 25 reads the dummy metal pre-insertion layout information 142 from the storage 14, and calculates a parasitic capacitance of each of the nets included in the net list 141 based on the dummy metal pre-insertion layout information 142. Upon receipt of the all-dummy metal post-insertion layout information 222, the capacitance calculation unit 25 calculates a parasitic capacitance of each of the nets included in the net list 141 based on the all-dummy metal post-insertion layout information 222. The capacitance calculation unit 25 calculates, for each of the nets, a difference between a parasitic capacitance of a net before the dummy metal insertion and a parasitic capacitance of a net after all dummy metal insertion. The information indicating the calculated difference in capacitance between before and after the dummy metal insertion for each net is sent to the net classification unit 21 as capacitance difference information 251.

Upon receipt of the capacitance difference information 251, the net classification unit 21 classifies all the nets in the net list 141 into groups in accordance with a predetermined algorithm. Specifically, for example, the net classification unit 21 classifies nets having products of a toggle rate and a capacitance difference (toggle rate×capacitance difference) that are close to each other into one group. The range of products of a toggle rate and a capacitance difference classified into a same group and the number of classification groups can be determined as appropriate. The net list 141 classified into the groups by the net classification unit 21 is sent to the layout information generator 22 as the post-classification net list 211.

The circuit design device 1 having the above-described functional configuration can perform the dummy metal insertion processing in consideration of the differences in capacitance of the nets between before and after the dummy metal insertion, in addition to the toggle rates.

4.2 Flowchart of Dummy Metal Insertion Processing

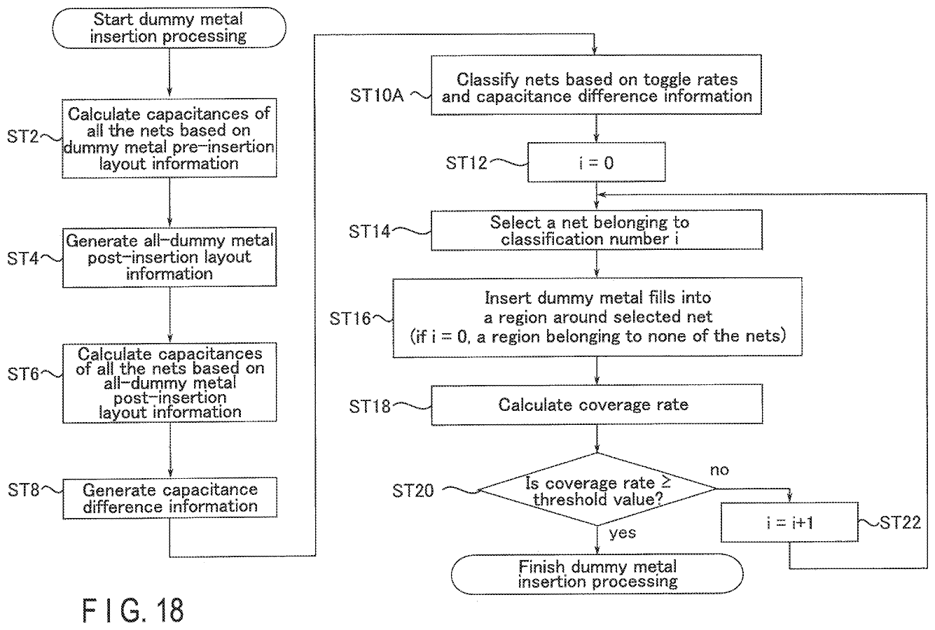

FIG. 18 is a flowchart for explaining the dummy metal insertion processing in the circuit design device according to the fourth embodiment, and corresponds to FIG. 5 of the first embodiment. The circuit design device 1 performs step ST10A instead of step ST10 shown in FIG. 5, and further performs steps ST2 through ST8. The circuit design device 1 functions as the capacitance calculation unit 25 in steps ST2, ST6, and ST8 in FIG. 18, as the layout information generation unit 22 in step ST4, and as the net classification unit 21 in step ST10A.

As shown in FIG. 18, in step ST2, the capacitance calculation unit 25 calculates a parasitic capacitance of each net based on the dummy metal pre-insertion layout information 142.

In step ST4, the layout information generation unit 22 generates the all-dummy metal post-insertion layout information 222 in which dummy metal fills are inserted into all the insertable positions, based on the dummy metal pre-insertion layout information 142.

In step ST6, upon receipt of the all-dummy metal post-insertion layout information 222 generated in step ST4, the capacitance calculation unit 25 calculates a parasitic capacitance of each of the nets based on the all-dummy metal post-insertion layout information 222.

In step ST8, the capacitance calculation unit 25 calculates, for all of the nets, differences between the parasitic capacitances calculated in step ST2 and the parasitic capacitances calculated in step ST6, and generates the capacitance difference information 251.

In step ST10A, the net classification unit 21 sorts all the nets included in the net list 141 based on a product of a toggle rate and the capacitance difference information 251 generated in step ST8, and classifies the nets by a predetermined range of the value of the product.

Since the steps ST12 through ST22 are the same as those shown in FIG. 5 of the first embodiment, descriptions of the steps are omitted.

The dummy metal insertion processing is thus finished.

4.3 Advantageous Effects of Fourth Embodiment According to the fourth embodiment, the capacitance calculation unit 25 calculates a parasitic capacitance of a net each of before and after an increase in a parasitic capacitance due to dummy metal on the basis of the dummy metal pre-insertion layout information 142 and the all-dummy metal post-insertion layout information 222. The capacitance calculation unit 25 calculates an increase in parasitic capacitance due to dummy metal by calculating a difference between these parasitic capacitances. The net classification unit 21 classifies the nets N1 to N9 into a plurality of groups in accordance with values of the products of a toggle rate and a parasitic capacitance difference. It is thereby possible to determine a region where an increase in power consumption is small even after the dummy metal insertion, in consideration of the two parameters contributing to the increase of the power consumption, namely the toggle rate and the increase in the parasitic capacitance.

### 5. Others

The above-described first through fourth embodiments can be modified in various manners as appropriate.

For example, in the first through fourth embodiments, the example where the layout of nets and dummy metal fills can be expressed in a two-dimensional manner is described; however, the embodiments are not limited to this example. For example, in the first through fourth embodiments, the layout of nets and dummy metal fills may be a three-dimensional arrangement provided in a stack of multiple layers on a substrate.

In the fourth embodiment, the example where dummy metal is inserted after classifying the nets based on a product of a toggle rate and a difference between parasitic capacitances through a technique similar to that in the first embodiment is described; however, the embodiment is not limited thereto. For example, in the fourth embodiment, dummy metal may be inserted with a technique similar to that in the second and third embodiments.

In the fourth embodiment, the example where the layout information generation unit 22 inserts dummy metal into all the regions that allow insertion and generates the all-dummy metal post-insertion layout information 222 is described; however, the fourth embodiment is not limited to this example. For example, the all-dummy metal post-insertion layout information 222 does not require insertion of dummy metal into all the regions, as long as dummy metal is inserted, for all the nets, into a region where a significant increase in a parasitic capacitance is predicted.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit.

What is claimed is:

1. A circuit design device comprising:
a classification unit configured to classify a plurality of wires included in a circuit into a first wire group that includes at least one first wire and a second wire group that includes at least one second wire based on toggle rates of the plurality of wires; and
a generation unit configured to generate, based on first information indicating a layout of the plurality of wires on a substrate, second information indicating a layout of the plurality of wires on the substrate and a first dummy wire, the first dummy wire being arranged in a first region within a first range from the first wire.

2. The device of claim 1, further comprising:
a first calculation unit configured to calculate a coverage rate of the plurality of first wires and the first dummy wire with respect to the substrate based on the second information; and
an output unit configured to output the second information to an external device of the device if the coverage rate is equal to or greater than a threshold value.

3. The device of claim 1, wherein
a toggle rate of the first wire is smaller than a toggle rate of the second wire.

4. The device of claim 1, wherein
the generation unit is configured to generate, based on the first information, third information indicating a layout of the plurality of wires on the substrate and a plurality of dummy wires, each of the plurality of dummy wires being arranged in a region within the first range from a corresponding wire among the plurality of wires,
the device further comprises a second calculation unit configured to calculate differences between capacitances of the plurality of wires based on the first information and capacitances of the plurality of wires based on the third information, and
the classification unit is configured to classify the plurality of wires into the first wire group and the second wire group based on the calculated differences between the capacitances.

5. The device of claim 4, wherein
a product of a toggle rate of the first wire and a difference between capacitances of the first wire is smaller than a product of a toggle rate of the second wire and a difference between capacitances of the second wire.

6. The device of claim 1, wherein
the first dummy wire is arranged within the first region and outside of a second region within the first range from the second wire.

7. The device of claim 1, wherein
the first dummy wire is arranged within the first region and outside of a second region within a second range from the second wire, the second range being different from the first range.

8. The device of claim 7, wherein
the second range is larger than the first range.

9. The device of claim 2, wherein
the second wire group includes a plurality of second wires,
the classification unit is configured to classify, based on toggle rates, the plurality of second wires into a third wire group that includes at least one third wire and a fourth wire group that includes at least one fourth wire,
the generation unit is configured to generate, if the coverage rate is smaller than the threshold value, based on the second information, fourth information indicating a layout of the plurality of wires on the substrate, the first dummy wire and a second dummy wire being arranged in a third region within the first range from the third wire.

10. The device of claim 9, wherein
a toggle rate of the first wire is smaller than toggle rates of the plurality of second wires, and
a toggle rate of the third wire is smaller than a toggle rate of the fourth wire.

11. The device of claim 1, wherein
each of the plurality of wires is electrically coupled to at least one of a plurality of terminals included in the circuit, and
the first dummy wire is electrically cut off from the plurality of terminals.

12. The device of claim 2, wherein
the output unit is configured to display the second information to a user.

13. The device of claim 12, wherein
the device includes a processor configured to function as the classification unit, the generation unit, and the first calculation unit.

14. The device of claim 13, wherein
the circuit design device further comprises a storage configured to store fifth information that includes toggle rates respectively corresponding to the plurality of wires, and the first information.

15. A circuit design method executed by a device, the method comprising:
classifying a plurality of wires included in a circuit into a first wire group that includes at least one first wire and a second wire group that includes at least one second wire based on toggle rates of the plurality of wires;
generating, based on first information indicating a layout of the plurality of wires on a substrate, second information indicating a layout of the plurality of wires on the substrate and a first dummy wire arranged in a first region within a first range from the first wire;
calculating a coverage rate of the plurality of wires and the first dummy wire with respect to the substrate based on the second information; and
outputting the second information to an external device if the coverage rate is equal to or greater than a threshold value.

16. A non-transitory computer readable storage medium storing a program used by a processor, the program causing the processor to:
classify a plurality of wires included in a circuit into a first wire group that includes at least one first wire and a second wire group that includes at least one second wire based on toggle rates of the plurality of wires;
generate, based on first information indicating a layout of the plurality of wires on a substrate, second information indicating a layout of the plurality of wires on the substrate and a first dummy wire arranged in a first region within a first range from the first wire;
calculate a coverage rate of the plurality of wires and the first dummy wire with respect to the substrate based on the second information; and
output the second information to an external device if the coverage rate is equal to or greater than a threshold value.
